(19) United States
(12) Patent Application Publication
(10) Pub. No.: US 2017/0270451 A1
(43) Pub. Date: Sep. 21, 2017

(54) ITEM-BASED COMMUNICATION SYSTEM

(71) Applicant: Invaware Corporation, Ingersoll (CA)

(72) Inventors: Michael David Ulch, London (CA); Stephan Ernst Bohner, Woodstock (CA)

(21) Appl. No.: 15/460,148

(22) Filed: Mar. 15, 2017

Related U.S. Application Data
(60) Provisional application No. 62/309,846, filed on Mar. 17, 2016.

(51) Int. Cl. G06Q 10/06

(52) U.S. Cl. CPC G06Q 10/06315

(57) ABSTRACT

A system for item-based communication between purchaser personnel and supplier personnel within a Enterprise Resource Planning (ERP) using environment that utilizes ERP software. The purchaser and supplier personnel have computing devices connectable to one another over a two-way data communication network. The computing devices are equipped with a communication interface for transmitting messages between the purchaser and supplier personnel via an intermediate item data server. Each message is connected to a particular item identifier. The item data server is connected to the ERP software and permits the personnel to obtain item information from the ERP software that is a subset of all information in the ERP software relating to the particular item identifier. The item data server also includes a database for storing the messages in connection with the item identifier. The purchaser and supplier personnel are able to view the purchaser item information and stored messages relating to the item identifier using the communication interface.

### CROSS-REFERENCE TO RELATED APPLICATIONS

This application claims the benefit of U.S. patent application 62/309,846 filed Mar. 17, 2016, the entire contents of which are incorporated herein by reference.

### FIELD

The following relates to electronic information exchange, particularly data communication systems, more particularly data communication systems in an Enterprise Resource Planning (ERP) using environment, for example between purchaser personnel and supplier personnel, relating to unique item identifiers.

### BACKGROUND

ERP software has gained widespread use in manufacturing, warehousing and distribution environments in order to link demand forecasting, inventory management, item ordering and shipping information along with accounting information in a centralized repository. Since there is so much sensitive information contained in the ERP system, not all employees of an ERP using organization are provided access to all information. In particular, in a manufacturing environment, production employees on the shop floor typically either do not have access to the ERP system or have highly restricted access. When those production employees are faced with either a shortage of items (e.g. parts) in inventory with which to continue their work or an expected upcoming shortage of parts due to forecasted production demands, they cannot readily determine whether replacement parts have been ordered or, if ordered, when they are expected to arrive. This problem is exacerbated when rush delivery orders are received.

In the past, communication has either been conducted in person or via email. Such communication systems lack transparency for all members of a particular group of employees (e.g. production employees, buying employees, such as buyers, shipping and receiving employees or quality assurance employees). As a result, incoming item or part orders that are needed for a rush delivery can be held up within the ERP using environment. In addition, there is no easy way for external supplier employees to see upcoming orders or rush orders for particular items or parts within the ERP system. This tends to force all communication between purchaser and supplier personnel to occur between a few designated individuals that have access to required information within their respective ERP systems, which limits widespread knowledge and appropriate planning.

There is a need for an improved communication system between purchaser and supplier personnel that mitigates some or all of the aforementioned deficiencies of current approaches.

### SUMMARY

In one aspect, there is provided a system for item-based communication within an ERP using environment that purchases items (or parts) using a purchaser Enterprise Resource Planning (ERP) software, the system comprising: a first computing device accessible to purchaser personnel within the ERP using environment, a second computing device accessible to supplier personnel of suppliers of the ERP using environment, the first and second computing devices connectable over a network permitting two-way data communication; a communication interface on the first and second computing devices for transmitting messages over the network, the messages between the purchaser personnel and the supplier personnel via an intermediate item data server, each message being connected to a particular item identifier; the item data server connected to the purchaser ERP software and permitting the purchaser personnel and supplier personnel to obtain purchaser item information from the purchaser ERP software via the communication interface, the purchaser item information comprising a subset of all information of the purchaser ERP software relating to the item identifier, the item data server further comprising a database for storing the messages in connection with the item identifiers; and, wherein the purchaser personnel and supplier personnel are able to view the purchaser item information and stored messages from purchaser personnel and supplier personnel concerning the item identifier using the communication interface.

The term “ERP using environment” as used herein encompasses a purchasing organization that purchases items or components and uses ERP software, for example a distribution organization (e.g. mass market retailers) or a manufacturing organization, along with suppliers to that organization. Such an organization can include one or more incorporated entities, one or more facility locations within the organization, or one or more locations within a particular facility. The purchasing organization can include purchaser personnel from a variety of different departments, disciplines or groups, such as production personnel, buying personnel (for example, buyers), shipping and receiving personnel, quality assurance personnel, accounting personnel, or the like.

The term “supplier” is meant to denote a separate organization that has a business relationship with the purchasing organization whereby items are provided within the ERP using environment. The supplier may be a manufacturer of parts or a distributor of items. Supplier personnel can come from a variety of different departments, disciplines or groups, such as production personnel, sales personnel, shipping and receiving personnel, quality assurance personnel, accounting personnel, or the like.

The term “shipper” is meant to denote a separate organization that has a business relationship with the purchasing organization or the supplier whereby items are shipped from the supplier to the purchaser within the ERP using environment. For example, the shipper may be a courier service or trucking service provider. Shipper personnel can come from a variety of different departments, disciplines or groups, such as logistics co-ordinators, delivery drivers, or the like.

The term “computing device” is meant to include mobile devices, such as smartphones and tablets, and computers, such as laptop and desktop computers. The computing device may be accessible to an individual or to a group of people.

The term “network permitting two-way data communication” can include local area networks (LAN's) and wide area networks (WAN's), incorporating wired or wireless architectures. A cellular network can also be included, as can any network providing internet connectivity.

The term “ERP software” is known to persons of skill in the art and includes a variety of types of software that link demand forecasting, inventory management, item ordering and shipping information along with accounting information in a centralized repository. Examples of ERP software vendors include SAP™, Oracle™, Infor™, Microsoft™, Kronos™ and a number of others. A non-exhaustive list of available ERP software can be found at en.wikipedia.org/wiki/List of ERP software packages.

The item identifier may comprise an item number (or other indicia identifying the item) belonging to either the purchase or the supplier. The item identifier may comprise more than one item number, enabling purchaser personnel and supplier personnel to cross-reference messages and item information using an item number that is convenient to them.

The intermediate item data server can be a physical machine or virtual machine and can be located on a LAN or WAN, for example accessible via the internet. In some embodiments, the intermediate item data server is a cloud-based computing resource accessible by the computing devices over the internet. The intermediate item data server can take the form of a module implemented from within a particular ERP software, or can be separately implemented. Due to the need for data security and to prohibit unauthorized access to ERP information, the intermediate item data server is usually separately implemented, but has secure connectivity to the ERP software in order to query the software for required information.

The information available to the intermediate item data server may be some or all of the information in the ERP software. Regardless, item information available to purchaser and supplier personnel via the intermediate item data server is a subset of all available ERP information. The intermediate item data server may have access only to the subset of information.

The item data server may comprise a data access control module whereby an administrator of the system can configure which information of the purchaser ERP software relating to the item identifier to include in the subset. For example, the purchaser item information may comprise inventory, ordering and shipping information of the purchaser ERP software relating to the item identifier. The inventory information may include a quantity currently in stock of the item represented by the item identifier, a quantity of the item that is currently committed to existing orders, or a location within the ERP using environment where the item is located. The ordering information may comprise a quantity that has been ordered, an order date, or lead time information for orders. The shipping information may comprise quantity, date and shipment information, for example information concerning shipment expediting. The purchaser item information may further comprise demand forecast information. The demand forecast information may include current order quantities requiring the item, order dates, delivery dates, expected order quantities requiring the item or expected delivery dates.

The item data server may comprise a personnel access control module whereby an administrator can configure which information of the purchaser ERP software relating to the item identifier to include in the subset accessible to the purchaser personnel. For example, production personnel may have access to less information about the item represented by the item identifier than buyers. When there is a plurality of purchaser personnel comprising production, buying and shipping personnel groups, the personnel access control module may permit the administrator to configure which information of the purchaser ERP software relating to the item identifier to include in the subset accessible to each of the personnel groups. Personnel groups can comprise one person or a plurality of people having similar job functions or requiring access to similar information.

The personnel access control module may permit the administrator to configure message conditions that determine whether messages from a particular group are viewable by members of another group or by supplier personnel. For example, messages from the production personnel group may not be visible by the supplier personnel unless certain conditions are met. Similarly, messages from the buying personnel group to the supplier personnel may not be visible to the production personnel group unless certain conditions are met. The conditions may relate to the item identifier, so that messages pertaining to a certain plurality of item identifiers are accessible to one personnel group, but not to another personnel group that is not required to know about those item identifiers. This reduces the possibility for information overload of a particular personnel group. The conditions may relate to an item property associated with the item identifier, in a manner that will be more thoroughly described hereinafter.

The personnel access control module may permit the administrator to configure item conditions whereby purchaser item information is viewable by members of a particular group or by supplier personnel. The item conditions may comprise the item identifier, a demand forecast quantity, an inventory quantity, an ordered quantity, a shipped quantity, an ordered date or a shipped date. Threshold values may be set for these item conditions that trigger whether or not the purchaser item information is made available to a particular group or by supplier personnel. This reduces the possibility for information overload of a particular personnel group.

In some embodiments, members of the buying personnel group may be able to set an item property associated with an item identifier as expedited, in which case the message conditions and/or item conditions comprise whether the item property has been set to expedited. Satisfying these message conditions or item conditions may make messages relating to the item identifier or purchaser item information viewable by other personnel groups. Similarly, members of any personnel group may be able to set an item property associated with an item identifier to “hot”, in which case the message conditions and/or item conditions comprise whether the item property has been set to hot, thereby making the messages or purchaser item information relating to the item identifier viewable by other personnel groups. The first communication interface may further include a “hot list”, wherein messages concerning item identifiers with item properties that are set to hot or expedited are grouped. This facilitates easy access to communications and reduces information overload by prioritizing the most important item identifiers. The item data server may include a report generator that can be used to generate a report indicating the frequency with which an item identifier has its item property set to hot or expedited. This report can be useful in terms of highlighting process problems that result in a particular item identifier recurrently appearing on the hot list.

The personnel access control module may permit the administrator to configure which information of the purchaser ERP software relating to the item identifier to include in the subset of item information accessible to the supplier personnel. The supplier personnel can be treated as any other personnel group and have their access to certain item information based on an item condition.

The personnel access control module may permit the administrator to configure which information of the purchaser ERP software relating to the item identifier to include in the subset of item information accessible to each first computing device. In this manner, item information is controlled based on the computing device, either in addition to or as an alternative to controlling item information based on personnel identity or personnel group.

The intermediate item data server may be connected to a supplier ERP software permitting the purchaser personnel and supplier personnel to obtain supplier item information from the supplier ERP software via the communication interface. The supplier item information may comprise a subset of all information of the supplier ERP software relating to the item identifier. The supplier item information may comprise inventory, ordering and shipping information of the supplier ERP software relating to the item identifier. The inventory information may include a quantity currently in stock of the item represented by the item identifier, a quantity of the item that is currently committed to existing orders, or a location within the ERP using environment where the item is located. The ordering information may comprise a quantity that has been ordered, an order date, or lead time information for orders. The shipping information may comprise quantity, date and shipment information, for example information concerning shipment expediting. The supplier item information may further comprise demand forecast information. The demand forecast information may include current order quantities requiring the item, order dates, delivery dates, expected order quantities requiring the item or expected delivery dates.

The system may further comprise a third computing device accessible to shipping personnel of shippers of the ERP using environment. In this case, the first, second and third computing devices are connectable over a network permitting two-way data communication. The communication interface on the third computing device may be for transmitting messages over the network between the shipping personnel and the purchaser and supplier personnel via the intermediate item data server, each message being connected to the particular item identifier. In this manner, purchaser personnel and supplier personnel are able to be kept up to date on the status of pick-up and delivery of items corresponding to the item identifier and shipping personnel are able to view item information when item conditions, as determined by the administrator using the personnel access control means, permit them to have access to that information. This further streamlines communication between all personnel using the system.

Further features will be described or will become apparent in the course of the following detailed description. It should be understood that each feature described herein may be utilized in any combination with any one or more of the other described features, and that each feature does not necessarily rely on the presence of another feature except where evident to one of skill in the art.

### BRIEF DESCRIPTION OF THE DRAWINGS

For clearer understanding, preferred embodiments will now be described in detail by way of example, with reference to the accompanying drawings, in which:

FIG. 1 is a schematic representation of an item-based communication system;

FIG. 2 is a schematic representation of a data access control module;

FIG. 3 is a schematic representation of a personnel access control module

FIG. 4 is a schematic representation of item properties associated with the item identifier; and,

FIG. 5 is a schematic representation of another embodiment of an item-based communication system.

### DETAILED DESCRIPTION

Like elements are described with like reference numerals; thus, items shown or not shown on a particular drawing may be described in connection with another drawing containing the same reference numeral.

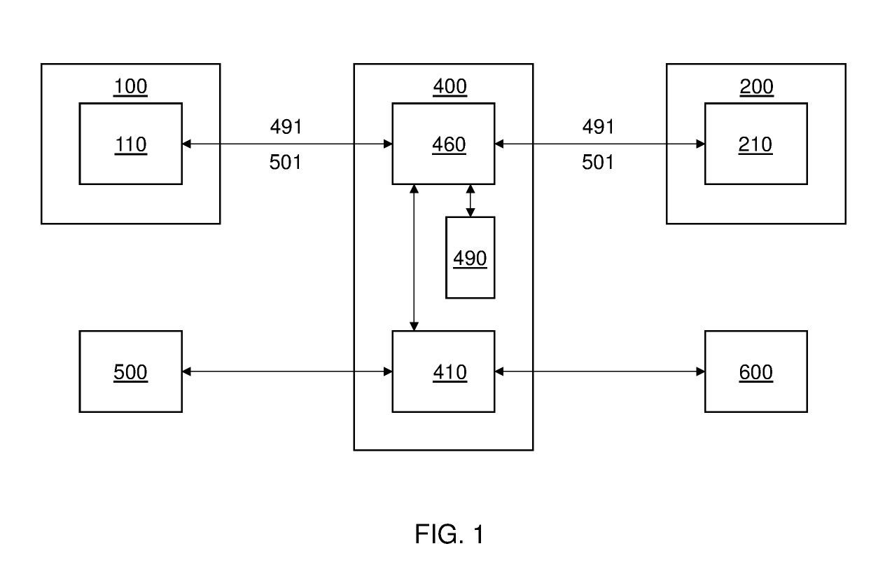

Referring to FIG. 1, an item-based communication system comprises a first computing device 100 accessible to purchaser personnel within the ERP using environment. A second computing device 200 is accessible to supplier personnel of suppliers of the ERP using environment. The first and second computing devices are connectable over a network permitting two-way data communication. The first computing device 100 comprises a communication interface 110 for transmitting messages 491 over the network. The second computing device 200 comprises a communication interface 210 for transmitting messages 491 over the network. Messages 491 are transmitted over the network between purchaser personnel and supplier personnel via an intermediate item data server 400. Each message 491 is connected to a particular item identifier 700; thus, the messages are item-based communications.

The item data server 400 is connected to the purchaser ERP software 500. In some embodiments, the item data server 400 is also connected to a supplier ERP software 600; however, since not all suppliers have an ERP software 600, this step is optional. The item data server 400 permits purchaser personnel and supplier personnel to obtain purchaser item information 501 from the purchaser ERP software 500 via the communication interfaces 110, 210. The purchaser item information 501 comprises a subset of all information of the purchaser ERP software 500 relating to the item identifier 700.

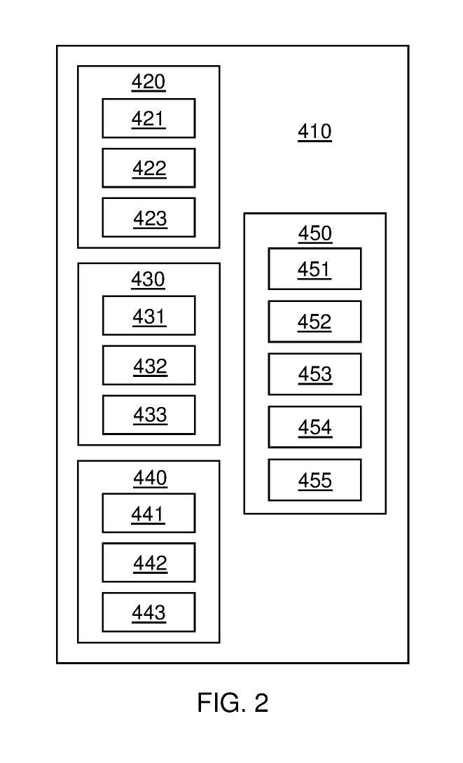

The item data server 400 comprises a data access control module 410. An administrator of the system can configure which information of the purchaser ERP software 500 relating to the item identifier 700 is included in the subset of information represented by the purchaser item information 501. Referring additionally to FIG. 2, the data access control module 410 can be used by the administrator to determine which inventory information 420, ordering information 430, shipping information 440 and, in some embodiments, demand forecast information 450 is included in the purchaser item information 501. The administrator can determine whether to provide inventory information 420 relating to a quantity currently in stock 421 of the item represented by the item identifier 700, a quantity currently committed 422 to existing sales orders, or a location within the ERP using environment 423 where the item is located. The administrator can determine whether to provide ordering information 430 relating to a quantity that has been ordered 431, an order date 432, or lead time information 433 for future orders. The administrator can determine whether to provide shipping information 440 concerning a quantity shipped 441, a shipment expected receipt date 442, or shipment information 443, for example comprising information concerning shipment method, shipment tracking number or shipment expediting. In cases where demand forecast information 450 is available within the purchaser ERP software 500, the administrator can determine whether to provide demand forecast information 450 concerning current sales order quantities 451 requiring the item, sales order dates 452, sales order delivery dates 453, expected sales order quantities 454 requiring the item, or expected sales order delivery dates 455.

The item data server 400 further comprises a personnel access control module 460. An administrator of the system can configure which information of the purchaser ERP software 500 relating to the item identifier 700 is included in the subset of information represented by the purchaser item information 501 accessible to the purchaser personnel. Thus, the personnel access control module 460 works with the data access control module 410 to determine which purchaser item information 501 is provided to a particular user or group of users of the purchaser personnel or supplier personnel.

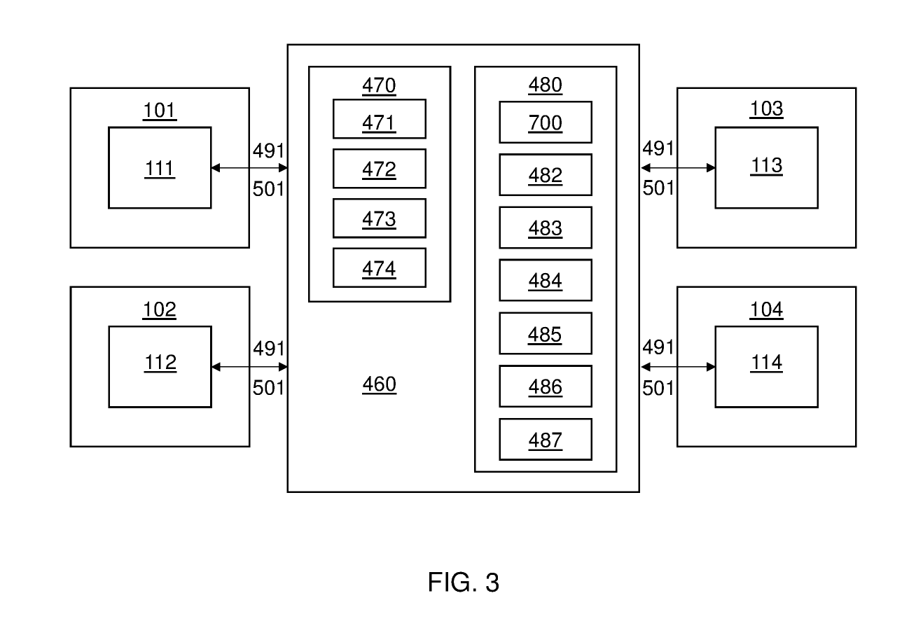

Referring additionally to FIG. 3, when there is a plurality of purchaser personnel comprising a production personnel group 471, a buying personnel group 472, a shipping personnel group 473, or a supplier personnel group 474, the personnel access control module 460 permits the administrator to configure which purchaser item information 501 is accessible to each of the personnel groups. The personnel access control module 460 also permits the administrator to configure message conditions 470 that determine whether messages 491 from a particular personnel group are viewable by members of another personnel group or by supplier personnel. The message conditions 470 will be more thoroughly described hereinafter. The personnel access control module 460 is interfaced with a database 490 configured to store messages 491 so that historical messages relating to a particular item identifier 700 are accessible only to the correct personnel groups. The personnel access control module 460 also permits the administrator to configure item conditions 480 that determine whether purchaser item information 501 is viewable by members of a particular personnel group or by supplier personnel. The item conditions 480 relate to the item identifier 700, a demand forecast quantity 482, an inventory quantity 483, an ordered quantity 484, a shipped quantity 485, an ordered date 486, or a shipped date 487.

As an alternative or in addition to controlling access to messages 491 or access to item information 501 in conjunction with the identity of purchaser or supplier personnel, the personnel access control module 460 can control access provided to a particular computing device. A plurality of first computing devices within the ERP using environment 101, 102, 103, 104 are each equipped with a communication interface 111, 112, 113, 114, respectively. Message conditions 470 and/or item conditions 480 are configured by the administrator to determine which messages 491 and purchaser item information 501 is accessible to each interface 111, 112, 113, 114.

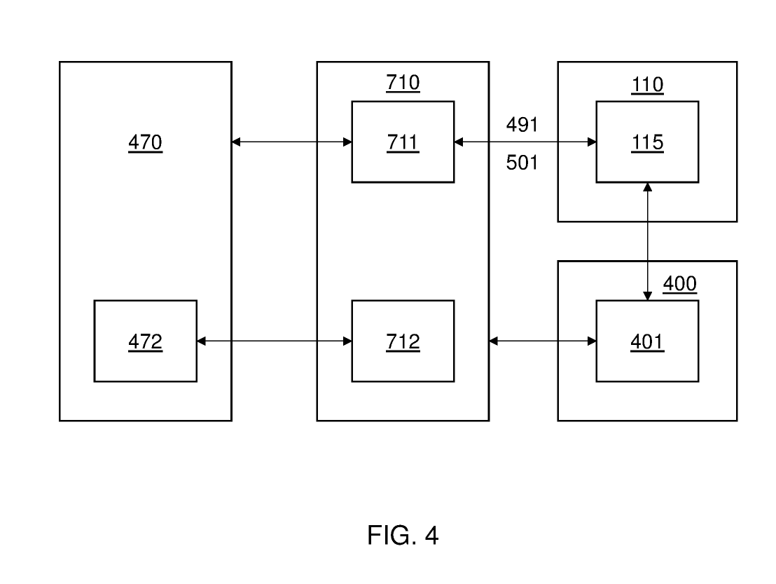

Referring to FIG. 4, each item identifier 700 is associated with one or more item properties 710. Members of the buying personnel group 472 are able to set the item properties 710 to expedited 712. Members of any personnel group are able to set the item properties 710 to hot 711. The administrator is able to set message conditions 470 such that a particular personnel group is provided access to messages 491 based upon the item properties 710 being either not set, set to expedited 712, or set to hot 711. Similarly, the administrator is able to set item conditions 480 such that a particular personnel group is provided access to purchaser item information 501 based upon the item properties 710 being either not set, said to expedited 712 or set to hot 711. The item properties 710 are therefore used to provide appropriate access to messages 491 and access to purchaser item information 501 to the first communication interface 110.

When the item properties 710 associated with a particular item identifier 700 are set to hot 711, the messages 491 and item information 501 relating to the item are displayed on a hotlist 115 displayed on the first communication interface 110. This ensures that items required urgently are given high visibility. The item data server 400 comprises a report generator 401 that can generate a report indicating the frequency with which a particular item identifier is marked as either hot 711 or expedited 712 and deliver it to the first communication interface 110. This report is useful in helping to determine whether there are process problems that lead to a particular item identifier recurrently being marked as hot 711 or expedited 712.

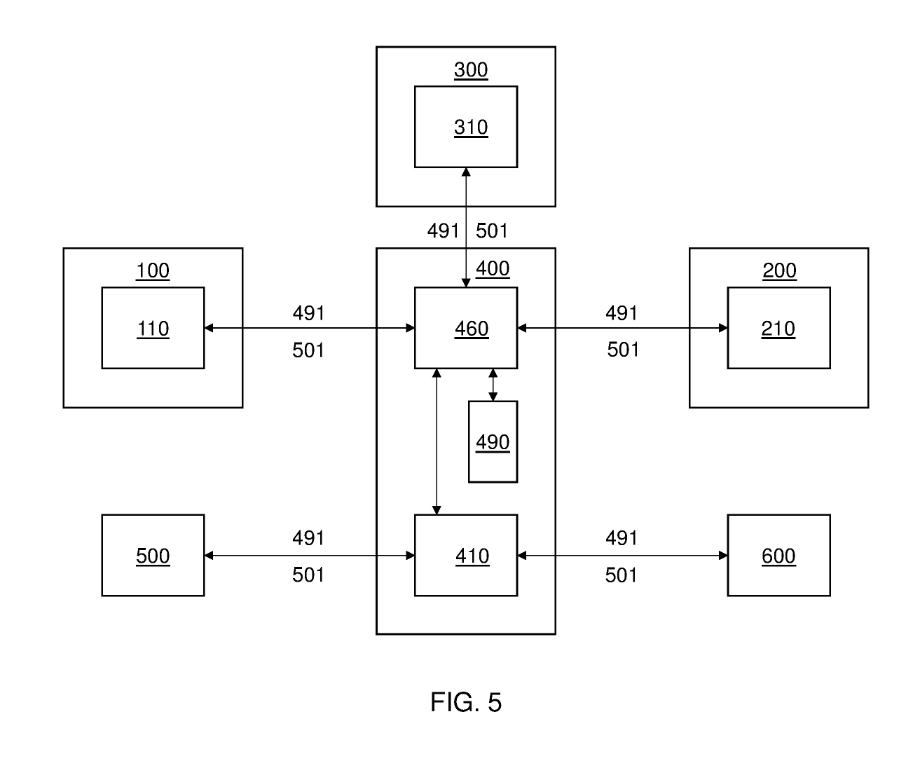

Referring to FIG. 5, in some embodiments, the system further comprises a third computing device 300 equipped with a third communication interface 310. Third communication device 300 is accessible to shipping personnel of shippers of the ERP using environment. The third computing device 300 is connectable over a network permitting two-way data communication with the first and second computing devices 100, 200. The communication interface 310 is configured for transmitting messages 491 over the network between the shipping personnel and the purchaser and supplier personnel via the intermediate item data server 400. Each message 491 is connected to the particular item identifier 700. The personnel access control module 460 functions the manner previously described to determine which purchaser or supplier personnel are able to communicate with the shipping personnel. Message conditions 470 and item conditions 480 may be used by the personnel access control module 460 to determine which information is provided to the third communication interface 310, in the manner as previously described.

The novel features will become apparent to those of skill in the art upon examination of the description. It should be understood, however, that the scope of the claims should not be limited by the embodiments, but should be given the broadest interpretation consistent with the wording of the claims and the specification as a whole.

1. A system for item-based communication within an Enterprise Resource Planning (ERP) using environment that utilizes a purchaser ERP software, the system comprising:
a first computing device accessible to purchaser personnel within the ERP using environment, a second computing device accessible to supplier personnel of suppliers of the ERP using environment, the first and second computing devices connectable over a network permitting two-way data communication;
a communication interface on the first and second computing devices for transmitting messages over the network, the messages between the purchaser personnel and the supplier personnel via an intermediate item data server, each message being connected to a particular item identifier;
the item data server connected to the purchaser ERP software and permitting the purchaser personnel and supplier personnel to obtain purchaser item information from the purchaser ERP software via the communication interface, the purchaser item information comprising a subset of all information of the purchaser ERP software relating to the item identifier, the item data server further comprising a database for storing the messages in connection with the item identifiers; and,
wherein the purchaser personnel and supplier personnel are able to view the purchaser item information and stored messages from purchaser personnel and supplier personnel concerning the item identifier using the communication interface.

2. The system according to claim 1, wherein the item data server comprises a data access control module whereby an administrator can configure which information of the purchaser ERP software relating to the item identifier to include in the subset.

3. The system according to claim 1, wherein the purchaser item information comprises inventory, ordering and shipping information of the purchaser ERP software relating to the item identifier.

4. The system according to claim 3, wherein the shipping information comprises quantity, date and shipment information.

5. The system according to claim 3, wherein the purchaser item information further comprises demand forecast information.

6. The system according to claim 1, wherein the item data server comprises a personnel access control module whereby an administrator can configure which information of the purchaser ERP software relating to the item identifier to include in the subset accessible to the purchaser personnel.

7. The system according to claim 6, wherein there are a plurality of purchaser personnel organized into purchaser personnel groups comprising production, buying and shipping personnel groups and wherein the personnel access control module permits the administrator to configure which information of the purchaser ERP software relating to the item identifier to include in the subset accessible to each of the purchaser personnel groups.

8. The system according to claim 7, wherein the personnel access control module permits the administrator to configure message conditions that determine whether messages from a particular purchaser personnel group are viewable by members of another purchaser personnel group or by supplier personnel and wherein the message conditions relate to an item property associated with the item identifier.

9. The system according to claim 8, wherein the personnel access control module permits the administrator to configure item conditions that determine whether purchaser item information is viewable by members of a particular purchaser personnel group or by supplier personnel and wherein the item conditions relate to the item identifier, a demand forecast quantity, an inventory quantity, an ordered quantity, a shipped quantity, an ordered date or a shipped date.

10. The system according to claim 9, wherein members of the buying personnel group are able to set the item property to expedited and wherein the message conditions or item conditions comprise whether the item property has been set to expedited.

11. The system according to claim 10, wherein members of any group are able to set the item property to hot and wherein the message conditions or item conditions comprise whether the item property has been set to hot.

12. The system according to claim 11, wherein the communication interface further includes a hot list wherein messages and purchaser item information relating to item identifiers with item properties that are set to hot or expedited are grouped.

13. The system according to claim 11, wherein the item data server comprises a report generator that generates a report indicating the frequency with which a particular item identifier appears on the hot list.

14. The system according to claim 6, wherein there are a plurality of first computing devices and wherein the personnel access control module permits the administrator to configure which information of the purchaser ERP software relating to the item identifier to include in the subset accessible to each first computing device.

15. The system according to claim 6, wherein the personnel access control module permits the administrator to configure which information of the purchaser ERP software relating to the item identifier to include in the subset accessible to the supplier personnel.

16. The system according to claim 1, wherein the item data server is connected to a supplier ERP software permitting the purchaser personnel and supplier personnel to obtain supplier item information from the supplier ERP software via the communication interface, the supplier item information comprising a subset of all information of the supplier ERP software relating to the item identifier.

17. The system according to claim 16, wherein the supplier item information comprises inventory, ordering and shipping information of the supplier ERP software relating to the item identifier.

18. The system according to claim 17, wherein the shipping information comprises quantity, date and shipment expediting information.

19. The system according to claim 16, wherein the supplier item information further comprises demand forecast information.

20. The system according to claim 1, wherein the system further comprises a third computing device accessible to shipping personnel of shippers of the ERP using environment, the first, second and third computing devices connectable over a network permitting two-way data communication, the communication interface on the third computing device for transmitting messages over the network between the shipping personnel and the purchaser and supplier personnel via the intermediate item data server, each message being connected to the particular item identifier.
